(19) United States
(12) Patent Application Publication
(10) Pub. No.: US 2004/0139180 A1
(43) Pub. Date: Jul. 15, 2004

(54) Automobile media synchronization

(75) Inventors: Larry Lee White, San Jose, CA (US); Kevin Lym, San Jose, CA (US)

Correspondence Address: HAVERSTOCK & OWENS LLP, 162 NORTH WOLFE ROAD, SUNNYVALE, CA, 94086, US

(73) Assignees: Sony Corporation; Sony Electronics, Inc.

(21) Appl. No.: 10/340,095

(22) Filed: Jan. 10, 2003

(51) Int. Cl. G06F 15/177

(52) U.S. Cl. 709/221

(57) ABSTRACT

A network of devices includes a home media server and a mobile media server. The mobile media server preferably resides within an automobile. A wireless hub couples the home media server to the mobile media server via wireless connections. In operation, when the automobile carrying the mobile media server comes within an operational range of the wireless hub, a first set of media residing on the home media server and a second set of media residing on the mobile media server are synchronized. Preferably, synchronization occurs automatically once the mobile media server is within range of the wireless hub. In this manner, two-way synchronization provides the same media on both the home media server and the mobile media server. Alternatively, media is synchronized one-way.

### FIELD OF THE INVENTION

The present invention relates to the field of synchronizing information between devices. More particularly, the present invention relates to the field of synchronizing media between media servers.

### BACKGROUND OF THE INVENTION

The Universal Plug and Play (UPnP) standard is designed to enable simple and robust connectivity among stand-alone devices and personal computers (PCs) from many different vendors. With UPnP, a device can dynamically join a network, obtain an Internet Protocol (IP) address, convey its capabilities, and learn about the presence and capabilities of other devices. Devices can subsequently communicate with each other directly, thereby enabling discovery and control of devices. UPnP uses standard Transmission Control Protocol/Internet Protocol (TCP/IP) and Internet protocols which facilitates interoperability with existing networks.

The basic building blocks of a UPnP network are devices, services and control points. A UPnP device is a container of services and nested devices. Different categories of UPnP devices are associated with different sets of services and embedded devices. For instance, services within a VCR are different than those with a printer. The set of services provided by a particular device, as well as a list of properties associated with the particular device, are captured in a device description document that the device must host. Preferably this device description document is written in Extensible Markup Language (XML).

A service exposes actions and models its state with state variables. For instance, a clock service can be modeled as having a state variable, current_time, which defines the state of the clock, and two actions, set_time and get_time, which enables control of the service. Similar to the device description, this information is part of a service description document preferably written in XML. The UPnP Forum defines UPnP Device and Service Descriptions according to a common device architecture. A pointer, such as a Uniform Resource Locator (URL), to each appropriate service description document is included within a device description document. Devices may include multiple services.

A service in a UPnP device includes a state table, a control server and an event server. The state table models the state of the service through state variables and updates them when the state changes. The control server receives action requests, such as set_time, executes the action requests, updates the state table and returns responses. The event server publishes events to interested subscribers anytime the state of the service changes. For instance, a fire alarm service sends an event to interested subscribers when its state changes to “ringing.”

A control point in a UPnP network is a controller capable of discovering and controlling other devices. After discovery of a network device, a control point can retrieve the device description and get a list of associated services, retrieve service descriptions for available services and invoke actions to control the service. The control point can also subscribe to the service's event source such that anytime the state of the service changes, the event server sends an event to the control point.

UPnP uses open, standard protocols such as TCP/IP, HyperText Transport Protocol (HTTP) and XML. Using these standardized protocols aids in ensuring interoperability between vendor implementations. Other technologies can also be used to network devices together. Such technologies include networking technologies such as Home Audio Video Interoperability (HAVi), Consumer Electronic Bus (CEBus), LonWorks, European Installation Bus (EIB), or X10. These too can participate in the UPnP network through a UPnP bridge or proxy.

A conventional protocol stack used to implement UPnP is illustrated in FIG. 1. The protocol stack includes a TCP/IP networking protocol stack 10, an HTTP layer 18, an HTTPU (HTTP unicast over User Datagram Protocol (UDP)) layer 20, an HTTPMU (HTTP multicast over UDP) layer 22, an SSDP (Simple Service Discovery Protocol) layer 24, a (ENA (General Event Notification Architecture) layer 26, a SOAP (Simple Object Access Protocol) layer 28, a UPnP Device Architecture Defined layer 30, a UPnP Forum Working Committee Defined layer 32 and a UPNP Vendor Defined layer 34. The TCP/IP protocol stack 10 includes an IP layer 16, a TCP layer 14 and a UDP layer 12. The TCP/IP networking protocol stack 10 serves as the base on which the rest of the UPnP protocols are built. By using the standard, prevalent TCP/IP protocol suite, UPnP leverages the protocol's ability to span different physical media and ensures multiple vendor interoperability. UPnP devices can use many of the protocols in the TCP/IP protocol suite including TCP, UDP, IGMP (Internet Group Multicast Protocol), ARP (Address Resolution Protocol) and IP as well as TCP/IP services such as DHCP (Dynamic Host Configuration Protocol) and DNS (Domain Name System). TCP/IP provides the base protocol stack for network connectivity between UPnP devices.

UPnP architecture defines the general interaction between UPnP control points and UPNP network devices containing audio/video (AV) media. The UPnP architecture is independent of any particular device type, content format, and transfer protocol. The UPnP architecture enables a UPnP control point to discover UPnP network devices within a network, and to enumerate the content available on each discovered UPnP network device. Each UPnP network device uses a UPnP Content Directory Service to compile detailed information about each content item on the UPnP network device. Each content item that is referenced by the Content Directory Service includes various information about the content item including the transfer protocol(s) and file format(s) that the UPnP network device storing the content item can use to transfer the content item to another UPnP network device.

In general, a UPnP control point discovers UPnP network devices within a network. The control point interacts with the discovered devices to locate desired content. Once the content is identified, the control point identifies a common transfer protocol and data format that can be used to transfer the content from the UPnP network device on which the content is located and a UPnP network device to which the content is to be transferred. After these transfer parameters are established, the control point controls the flow of content. The actual transfer of the content is performed directly by the two UPnP network devices. The content transfer happens independently from the control point and does not involve the UPnP protocol. The control point uses UPnP to initialize the transfer of the content, but the transfer is performed using a transfer protocol other than UPnP.

Synchronization Markup Language (SyncML) defines a mobile data synchronization protocol. SyncML synchronizes networked data with many different devices, including handheld computers such as personal digital assistants (PDAs), mobile phones, automotive computers, and desktop PCs. Mobile users are not always connected to a network and its stored data. Users retrieve data from the network and store it on the mobile device, where the mobile user can access and manipulate the local copy of the data. Periodically, users reconnect with the network to send any local changes back to the networked data repository. Users also have the opportunity to learn about updates made to the networked data while the mobile device was disconnected. Occasionally, conflicts need to be resolved among the updates made to the networked data. This reconciliation operation, where updates are exchanged and conflicts are resolved, is known as data synchronization. SyncML is a data synchronization protocol that defines workflow communication during a data synchronization session when the mobile device is connected to the network. SyncML supports naming and identification of records, common protocol commands to synchronize local and network data, and supports identification and resolution of synchronization conflicts.

The SyncML protocol includes two parts, the SyncML representation protocol and the SyncML sync protocol. The SyncML representation protocol focuses on organizing data contents of the synchronization. It defines methods for naming and identifying records. It also defines the XML document type used to represent a SyncML message, such as common protocol commands and message containers. The SyncML sync protocol focuses on managing the session operations of the synchronization. It defines the message flow between a SyncML client and server during a data synchronization session. The types of synchronization include one-way sync from the client only, one-way sync from the server only, two-way sync, and server alerted sync. The SyncML sync protocol also defines how to challenge authentication, how to initiate a synchronization session, and how to resolve conflicts. The SyncML messages are preferably transmitted using HTTP, Wireless Session Protocol (WSP), or Object Exchange protocol (OBEX). SyncML enables synchronization over wired and wireless networks, infrared, cable, or Bluetooth.

SyncML seeks to achieve universal synchronization such that synchronization servers Support synchronization with any mobile device and mobile devices are able to synchronize with any networked application. Examples of data that can be synchronized include e-mail, calendars, to-do lists, and contact information.

### SUMMARY OF THE INVENTION

A network of devices preferably includes a home media server and a mobile media server. The mobile media server preferably resides within an automobile. A wireless hub preferably couples the home media server to the mobile media server via wireless connections. In operation, when the automobile carrying the mobile media server comes within an operational range of the wireless hub, a first set of media residing on the home media server and a second set of media residing on the mobile media server are synchronized. Preferably, synchronization occurs automatically once the mobile media server is-within range of the wireless hub. In this manner, two-way synchronization provides the same media on both the home media server and the mobile media server. Alternatively, media is synchronized one-way.

In one aspect of the present invention, a network of devices comprises a first media server including a first set of media, and a second media server including a second set of media, wherein the first media server and the second media server are coupled to synchronize the first set of media and the second set of media. The first set of media and the second set of media are preferably automatically synchronized. The network of devices can also include a hub to couple the first media server to the second media server. The hub can be a wireless hub. The first media server and the second media server can be coupled to the wireless hub via wireless connections. The first media server can be coupled to the wireless hub via a wired connection and the second media server can be coupled to the wireless hub via a wireless connection. The first media server can comprise the hub. The first media server can comprise a stationary server. The second media server can comprise a mobile server. The mobile server can reside within an automobile. Media includes audio, video, and image data. The first media server and the second media server can be SyncML enabled devices. The first media server and the second media server can be UPnP enabled devices. Synchronization of the first set of media and the second set of media can be two-directional. Synchronization of the first set of media and the second set of media can be one-directional.

In another aspect of the present invention, a method comprises establishing communications between a first media server and a second media server, wherein the first media server includes a first set of media and the second media server includes a second set of media, and synchronizing the first set of media and the second set of media. The first set of media and the second set of media can be automatically synchronized. The method can further comprise applying a set of rules that determine specific media to be synchronized. The rules can determine if synchronization is allowed based on an identification of the second media server. The first media server can be coupled to the second media server via a hub. Communications between the first media server and the second media server can be established once the second media server moves within an operational range of the hub. Synchronizing the first set of media and the second set of media can include determining which media is to be transferred, and transferring the determined media.

In yet another aspect of the present invention, a network of devices comprises a home media server including a first set of media, a mobile media server including a second set of media, and a wireless hub coupled to the home media server and the mobile media server, wherein when the mobile media server moves within an operational range of the wireless hub a communication path is established between the home media server and the mobile media server, and the first set of media and the second set of media are synchronized. Synchronization can occur automatically once the mobile media server is within the operational range of the wireless hub. The home media server can comprise the hub. The mobile server can reside within an automobile. Media includes audio, video, and image data. The home media server and the mobile media server call be SyncML enabled devices. The home media server and the mobile media server can be UPnP enabled devices. Synchronization of the first set of media and the second set of media can be two-directional. Synchronization of the first set of media and the second set of media ca be one-directional.

### BRIEF DESCRIPTION OF THE DRAWINGS

FIG. 1 illustrates a conventional protocol stack used to implement the Universal Plug and Play (UPnP) standard.

FIG. 2 illustrates an exemplary network of devices.

FIG. 3 illustrates a block diagram of an exemplary hardware system resident in each system synchronizing media according to the present invention.

FIG. 4 illustrates a preferred method of synchronizing media according to the present invention.

FIG. 5 illustrates an alternative method of synchronizing media according to the present invention.

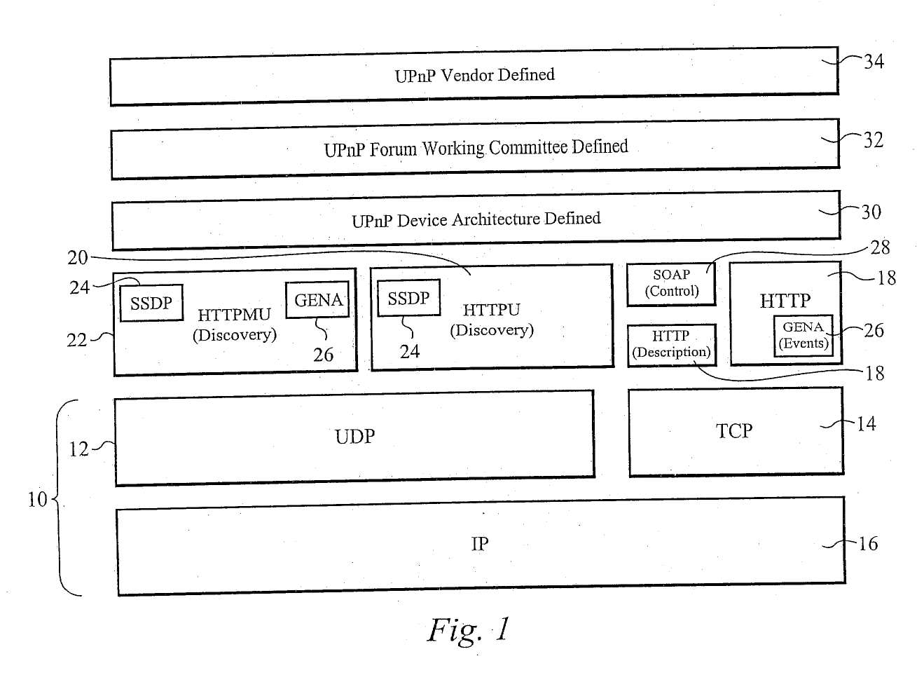

### DETAILED DESCRIPTION OF THE EMBODIMENTS

The present invention extends the function of conventional data synchronization methods to include the synchronization of media between two network devices. Media includes content, audio data, video data, images, graphics and the like. Embodiments of the present invention preferably include a home media server aid a mobile media server. The mobile media server preferably resides within an automobile. A wireless hub preferably couples the home media server to the mobile media server via wireless connections. In operation, when the automobile carrying the mobile media server comes within an operational range of the wireless hub, a first set of media residing on the home media server and a second set of media residing on the mobile media server are synchronized. Preferably, synchronization occurs automatically once the mobile media server is within range of the wireless hub. In this manner, two-way synchronization provides the same media on both the home media server and the mobile media server. Alternatively, media is synchronized one-way. In this alternative case, the first set of media on the home media server can be synchronized with the mobile media server such that the first set of media includes the second set of media from the mobile media server. For example, if the mobile media server includes an audio CD, then when the automobile drives within range of the wireless hub, the audio CD is automatically copied onto the home media server if the home media server does not already include a copy of the audio CD. This one-way synchronization process can also be reversed such that the second set of media on the mobile media server can be synchronized with the home media server such that the second set of media includes the first set of media from the home media server, or selective or pre-identified media from the home media server.

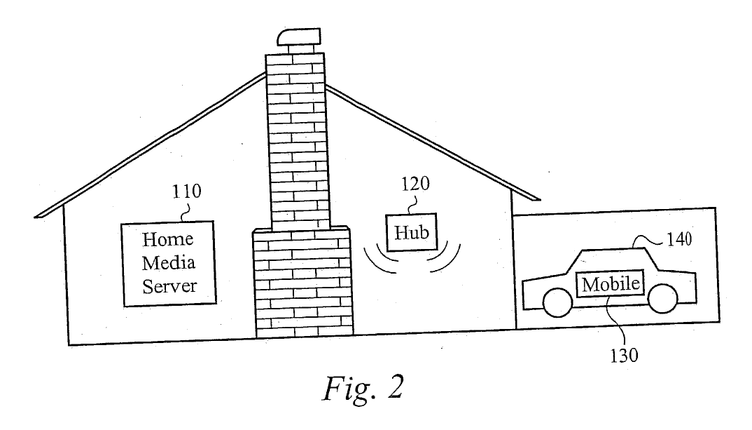

FIG. 2 illustrates an exemplary network of devices including a home media server 110, a hub 120 and a mobile media server 130. The hub 120 is preferably a wireless hub. The home media server 110 is preferably coupled to the hub 120 via a first wireless connection and the mobile media server 130 is preferably coupled to the hub 120 via a second wireless connection. The first and second wireless connections allow the home media server 110 to synchronize data with the mobile media server 130 via the hub 120. Preferably, the synchronized data is content or media including, but not limited to, audio, video and image data. Alternatively, the hub 120 can be any hub capable of facilitating the transfer of media to and from the home media server 110 and the mobile media server 130 including networked or wired connections. Although the home media server 110 is preferably coupled to the hub 120 via the first wireless connection, the home media server 110 can also be coupled to the hub 120 via a wired connection. The home media server 110, hub 120, and the mobile media server 130 are preferably separate devices. Alternatively, the home media server 110 and the hub 120 are resident within the same device, or the hub 120 and the mobile media server 130 are resident within the same device. The mobile media server 130 preferably resides within an automobile 140. Alternatively, any means can be used which makes the mobile media server 130 mobile. For example, the mobile media server 130 can be included within a portable CD player which a user can take remotely. It should be clear to those skilled in the art that the exemplary network of devices illustrated in FIG. 2 can include additional media servers, either mobile or stationary, and additional hubs.

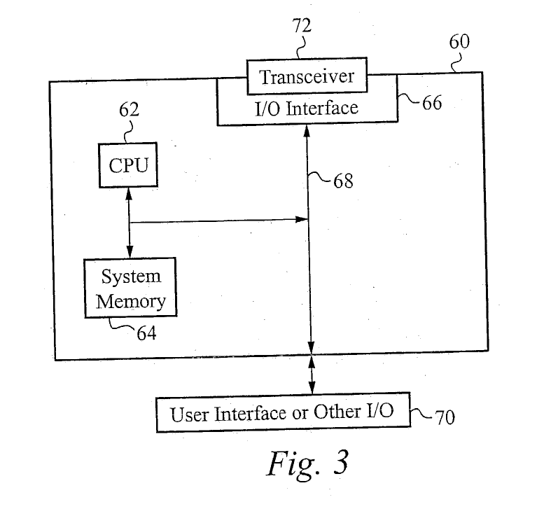

A block diagram of an exemplary hardware system resident in each system implementing a media server capable of synchronizing media according to the present invention is illustrated in FIG. 3. In the hardware system illustrated in FIG. 3, a printed circuit board 60 is coupled to a user interface 70. The printed circuit board 60 includes a central processing unit (CPU) 62 coupled to system memory 64 and to an I/O network interface 66 by a system bus 68. A transceiver 72 is coupled to the I/O network interface 66 for transmitting media and/or content to and receiving media and/or content from another network device. The user interface 70 is also coupled to the system bus 68. The user interface 70 is subsystem specific, but can include a keyboard, display or other I/O devices for communicating with a user of the subsystem. It should be apparent to those skilled in the art that there may be some devices which do not include the user interface 70, such as an external or stand-alone hard disk drive or other similar device.

Each subsystem intending to implement the media server of the present invention will preferably include a hardware system such as the system illustrated in FIG. 3. As applied to the network of devices illustrated in FIG. 2, the home media server 110 and the mobile media server 130 each include the hardware system of FIG. 3. The CPU 62 within each of the home device server 110 and the mobile media server 130 is used to execute the appropriate program instructions necessary for synchronizing media between the two devices.

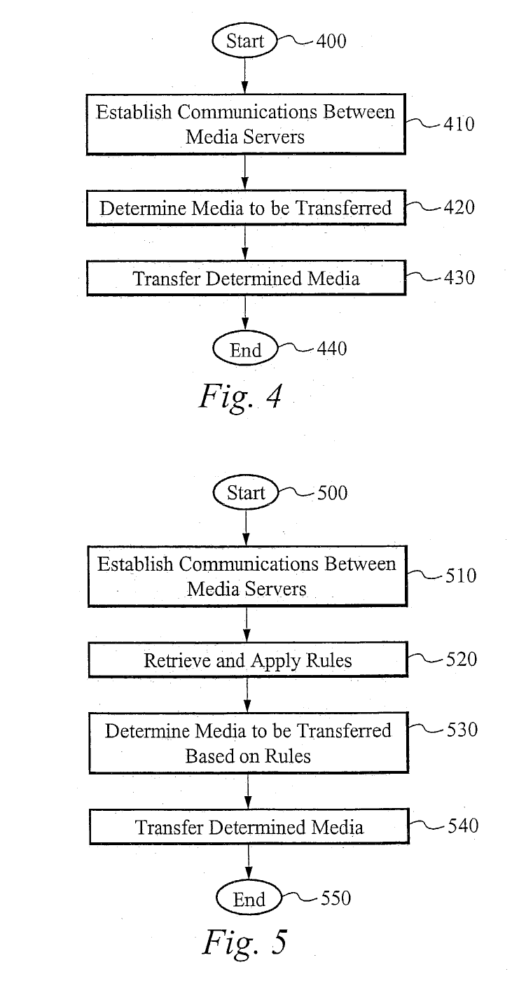

A preferred method of synchronizing media between a home media device and a mobile media device is illustrated in FIG. 4. The preferred method begins at the step 400. At the step 410, communications are established between the home media server and the mobile media server. In the preferred embodiment, the home media server and the mobile media server are each coupled via a wireless connection to a wireless hub. Communication is established between the home media server and the mobile media server once the mobile media server is within an operational range of the wireless hub and the mobile home server, and a communication link is established using accepted wireless protocols, for example 802.11b or Bluetooth. It should be clear to those skilled in the art that other wireless protocols can also be used. It should also be clear to those skilled in the art that in the alternative case where a wired connection is established between the hub and one or both of the home media server and the mobile media server, then any appropriate protocol for wired connectivity can be used.

After communications are established in the step 410, media to be transferred between the home media server and the mobile media server is determined at the step 420. Preferably, all media on both media servers is synchronized, that is all media resident on the home media server is to be on the mobile media server and vice versa. Preferably, all media on the home media server is discovered and compared to all media discovered on the mobile media server. In this case, any media discovered on one media server, but not the other, is flagged for transfer. Preferably, both the home media server and the mobile media server are UPnP enabled devices and the discovery of the media on each device is accomplished using the UPnP Content Directory Service.

Once all necessary media is flagged for transfer in the step 420, the flagged media is transferred in the step 430. In this manner, any media discovered on the home media server but not discovered on the mobile media server is copied onto the mobile media server, and any media discovered on the mobile media server but not discovered on the home media server is copied onto the home media server. Preferably, both the home media server and the mobile media server are SyncML enabled devices, and the synchronization of media between the two media devices, including the transfer of media between the two media servers, is facilitated using the SyncML protocol and the UPnP protocol. Alternatively, media servers can be enabled to use other protocols for enabling discovery, transfer, and synchronization of media. Synchronizing media in this manner, such that both media servers include the same media, is referred to as two-way synchronization. Once all flagged media is transferred at the step 430, the preferred synchronization method ends at the step 440.

Alternative methods of synchronizing media can also be implemented in which synchronizing does not begin until a user initiates the process. For example, if a car includes a mobile media server, where the mobile media server is part of the car's audio system, and the car is driven within range of a home media server, synchronization does not occur in this alternate embodiment until the driver initiates the process by pushing a corresponding button on the car audio system.

Rules can be implemented which dictate what media can be flagged for transfer, to whom the flagged media can be sent, and when the flagged media can be sent. These rules are preferably stored in the home media server. Alternatively, the rules can be stored in any media server.

FIG. 5 illustrates an alternative method of synchronizing media between a home media device and a mobile media device. The alternative method begins at the step 500. At the step 510, communications are established between the home media server and the mobile media server in the same manner as described above in relation to the preferred method. After communications are established in the step 510, rules of operation are retrieved and applied in the step 520. The rules preferably reside within the system memory of the home media server. Rules can also be resident within the system memory of the mobile media server. Rules provide restrictions on the media synchronization. Rules can dictate what media can be flagged for transfer, to whom the flagged media can be sent, and when the flagged media can be sent. It should be clear to those skilled in the art that other rules can be implemented which dictate restrictions on the media synchronization process. After the rules are applied in the step 520, then at the step 530, the media to be transferred between the home media server and the mobile media server is determined based on the rules. The rules include whether the synchronization is one-way or two-way, and if one-way, in which direction. Once all necessary media is flagged for transfer in the step 530, the flagged media is transferred in the step 540. Once all flagged media is transferred at the step 540, the alternative synchronization method ends at the step 550.

In an alternative embodiment, the mobile media server call establish communications with media servers other than the home media server. Communications with other media servers is established in a similar manner as with the home media server. When the mobile media server is within an operational range of another media server, or within range of a hub coupled to another media server, media residing on the mobile media server can be synchronized with media residing on the other media server. This alternative embodiment can be used, for example, when the mobile media server resides within an automobile, and the automobile drives by a store equipped with a hub coupled to another media server. In this case, while the automobile drives by the store, media within the stores' media server, such as today's special sales, can be transmitted to the mobile media server.

In operation, a mobile media server comes within an operational range of a home media server and/or a hub coupled to the home media server. Preferably the hub is wireless. Once within range, a first set of media residing on the home media server and a second set of media residing on the mobile media server are synchronized. Preferably, synchronization occurs automatically once the mobile media server is within range of the wireless hub. In this manner, two-way synchronization provides the same media on both the home media server and the mobile media server. Alternatively, media is synchronized one-way.

The present invention has been described in terms of specific embodiments incorporating details to facilitate the understanding of the principles of construction and operation of the invention. Such references, herein, to specific embodiments and details thereof are not intended to limit the scope of the claims appended hereto. It will be apparent to those skilled in the art that modifications can be made in the embodiments chosen for illustration without departing from the spirit and scope of the invention. Specifically, it will be apparent to one of ordinary skill that while the preferred embodiment of the present invention uses the UPnP and SyncML protocols to enable discovery, transfer and synchronization of the media on the media servers, other protocols can be used to enable these functions.

What is claimed is:

1. A network of devices comprising:
a. a first media server including a first set of media; and
b. a second media server including a second set of media, wherein the first media server and the second media server are coupled to synchronize the first set of media and the second set of media.

2. The network of devices of claim 1 wherein the first set of media and the second set of media are automatically synchronized.

3. The network of devices of claim 1 further comprising a hub to couple the first media server to the second media server.

4. The network of devices of claim 3 wherein the hub is a wireless hub.

5. The network of devices of claim 4 wherein the first media server and the second media server are coupled to the wireless hub via wireless connections.

6. The network of devices of claim 4 wherein the first media server is coupled to the wireless hub via a wired connection and the second media server is coupled to the wireless hub via a wireless connection.

7. The network of devices of claim 3 wherein the first media server comprises the hub.

8. The network of devices of claim 3 wherein the first media server comprises a stationary server.

9. The network of devices of claim 8 wherein the second media server comprises a mobile server.

10. The network of devices of claim 9 wherein the mobile server resides within an automobile.

11. The network of devices of claim 1 wherein media includes audio, video, and image data.

12. The network of devices of claim 1 wherein the first media server and the second media server are SyncML enabled devices.

13. The network of devices of claim 1 wherein the first media server and the second media server are UPNP enabled devices.

14. The network of devices of claim 1 wherein synchronization of the first set of media and the second set of media is two-directional.

15. The network of devices of claim 1 wherein synchronization of the first set of media and the second set of media is, one-directional.

16. A method of synchronizing a first media server and a second media server comprising:
a. establishing communications between the first media server and the second media server, wherein the fist media server includes a first set of media and the second media server includes a second set of media; and
b. synchronizing the first set of media and the second set of media.

17. The method of claim 16 wherein the first set of media and the second set of media are automatically synchronized.

18. The method of claim 16 further comprising applying a set of rules that determine specific media to be synchronized.

19. The method of claim 18 wherein the rules determine if synchronization is allowed based on an identification of the second media server.

20. The method of claim 16 wherein the first media server is coupled to the second media server via a hub.

21. The method of claim 20 wherein communications between the first media server and the second media server are established once the second media server moves within an operational range of the hub.

22. The method of claim 16 wherein synchronizing the first set of media and the second set of media includes determining which media is to be transferred, and transferring the determined media.

23. A network of devices comprising:
a. a home media server including a first set of media;
b. a mobile media server including a second set of media; and
c. a wireless hub coupled to the home media server and the mobile media server, wherein when the mobile media server moves within an operational range of the wireless hub a communication path is established between the home media server and the mobile media server, and the first set of media and the second set of media are synchronized.

24. The network of devices of claim 23 wherein synchronization occurs automatically once the mobile media server is within the operational range of the wireless hub.

25. The network of devices of claim 23 wherein the home media server comprises the hub.

26. The network of devices of claim 23 wherein the mobile server resides within an automobile.

27. The network of devices of claim 23 wherein media includes audio, video, and image data.

28. The network of devices of claim 23 wherein the home media server and the mobile media server are SyncML enabled devices.

29. The network of devices of claim 23 wherein the home media server and the mobile media server are UPnP enabled devices.

30. The network of devices of claim 23 wherein synchronization of the first set of media and the second set of media is two-directional.

31. The network of devices of claim 23 wherein synchronization of the first set of media and the second set of media is one-directional.

32. A first media server configured to be synchronized with a second media server, the first media server comprising:
a. an interface circuit to provide communications between the first media server and the second media server, wherein the first media server includes a first set of media and the second media server includes a second set of media; and
b. a processing circuit coupled to the interface circuit to synchronize the first set of media and the second set of media.

33. The first media server of claim 32 further comprising a transceiver coupled to the interface circuit to send and receive communications between the first media server and the second media server.

34. The first media server of claim 32 wherein the interface circuit is coupled to a hub such that the hub couples the first media server to the second media server.

35. The first media server of claim 33 wherein the first media server is coupled to the hub via a wireless connection.

36. The first media server of claim 33 wherein the first media server is coupled to the hub via a wired connection.

37. The first media server of claim 33 wherein the hub resides within the first media server.

38. The first media server of claim 32 wherein the first media server comprises a stationary server.

39. The first media server of claim 32 wherein the first media server comprises a mobile server.

40. The first media server of claim 39 wherein the mobile server resides within an automobile.

41. The first media server of claim 32 wherein media includes audio, video, and image data.

42. The first media server of claim 32 wherein the first media server is SyncML enabled.

43. The first media server of claim 32 wherein the first media server is UPnP enabled.
